(19) United States
(12) Patent Application Publication
(10) Pub. No.: US 2003/0154411 A1
(43) Pub. Date: Aug. 14, 2003

(54) Medical records categorization and retrieval system

(76) Inventor: J. Kjell Hovik, Laguna Beach, CA (US)

Correspondence Address: CHARLES C. LOGAN II, 8282 UNIVERSITY AVENUE, LA MESA, CA, 91941, US

(21) Appl. No.: 10/071,627

(22) Filed: Feb. 11, 2002

(51) Int. Cl. H04L 9/00; G06F 17/60

(52) U.S. Cl. 713/202; 705/50

(57) ABSTRACT

A personal medical records retrieval system that allows a person to access their personal medical records from a remote medical records database 24 hours a day, 365 days a years from locations throughout the world. The remote medical records database has an Internet website and the person has a personalized access code for viewing his medical records from the database over the Internet. The database has a Firewall security and privacy/pirating protection system. A personalized access code can only be obtained by becoming a subscribing member to the personal medical records retrieval system. A subscriber may also receive a Smart Health Card that has a small computer (in the form of a computer chip with a memory embedded in it) that contains a person's medical history that can be read on a card reader in a physician's office, in a hospital, in emergency vehicles and any other place that is equipped with a card reader. The subscriber also receives a medical passport into which is inserted the Smart Health Card and it further comprises a CD-ROM disc that has a person's complete medical records on it and the disc can be read on any PC or laptop computer with proper authorization.

### BACKGROUND OF THE INVENTION

The present invention relates to medical records, and more specifically, to a personal medical records retrieval system.

Medical providers, such as physicians, create large volumes of patient information during the course of their business at health care facilities, such as hospitals, clinics, laboratories and medical offices. For example, when a patient visits a physician for the first time, the physician generally creates a patient file including the patients medical history, current treatments, medications, insurance and other pertinent information. This file generally includes the results of patient visits, including laboratory test results, the physician's diagnosis, medications prescribed and treatments administered. During the course of the patient relationship, the physician supplements the file to update the patient's medical history. When the physician refers a patient for treatment, tests or consultation, the referred physician, hospital, clinic or laboratory typically creates and updates similar files for the patient. These files may also include the patient's billing, payment and scheduling records.

Health care providers can use electronic data processing to automate the creation, use and maintenance of their patient records. However, these electronic data processing systems do not handle patient data in the wide variant of data formats typically produced by health care providers such as physicians, laboratories, clinic and hospitals. Physicians often use paper based forms and charts to document their observations and diagnosis. Laboratories also produce patient data in numerous forms, from x-ray and magnetic resonance images to blood test concentrations and electrocardiograph data. Clinics and hospitals may use a combination of paper based charts and electronic data for patient records. The same patient data may exist in remote patient files located at clinics, hospitals, laboratories and physicians offices. Similarly, patient files at one health care provider typically have different information than patient files at another care provider. When in use, patient files are generally not available to other health care providers. In addition, at the time of creation, patient data is generally not available for use by remotely located health care providers. Moreover, relationships among specific patient data, such as abnormal laboratory test results, prescribed mediations to address the abnormality, and specific treatments administered by the physician, may not be apparent in a patient file.

In the current environment, specific patient data is difficult to access when needed for analysis. A creation of patient data in remote locations exacerbates the problem. In addition, the wide variety of data formats for patient data hinders electronic processing and maintenance of patient files. Moreover, the use of a patient's file by one health care provider can preclude its simultaneous use by another health care provider. Ongoing consolidation of health care providers into large health maintenance organizations (HMO's) and Preferred Provider Organizations (PPO's) create issues in the transfer and maintenance of patient data in large enterprises having numerous remote locations. Under these circumstances, health care providers have difficulty providing effective treatment for their patients.

The transient nature of society has also increased the problem of a patient's physician obtaining an accurate picture of a patient's medical history so that a proper diagnosis and treatment can be prescribed. People are moving throughout the United States by personal choice, because of company transfers, to pursue new employment opportunities and for health reasons. This further increases the dispersion of a person and their families medical records and makes it extremely difficult for a treating physician to have the benefit of all of the records when making a diagnosis and recommending treatment. Additionally, people are currently traveling throughout the world and when they become ill in a foreign country, there is no way for the treating physician to adequately review a person's medical a records prior to making a diagnosis and recommending treatment.

In January 2002, it became federal law that an individual owns their own medical records. No one else owns them and the person does not have to share ownership with the physician. Only with the patient's consent, can a physician or hospital keep these records or provide these records to other physicians or hospitals.

It is an object of the invention to provide a novel medical information system that allows a person's records to be accessed at any time 24 hours a day and 365 days a year.

It is also an object of the invention to provide a novel medical information system that allows a person's medical records to be accessed at any time any place in the world.

It is another object of the invention to provide a medical information system that maintains a person's medical records at a central location.

It is an additional object of the invention to provide a novel medical information system that stores a person's medical records at a “firewall” secured location.

It is also an object of the invention to provide a novel medical information system that gives the patient full control his/her medical records.

It is another object of the invention to provide a novel medical information system that provides a person with a health card that is a small computer that the person can carry in their pocket. The health card has a computer chip with memory embedded. The health card contains the person's medical history.

### SUMMARY OF THE INVENTION

The initial step for a person to receive the benefits of the novel personal medical records retrieval system is for the person to fill out a questionnaire with personal history information called Personal Medical Profiling (PMP). This questionnaire may be filled out either online, or in the office of their personal physician. There is a fee for the person to enroll in the Personal Medical Records retrieval system. A subscribing patient signs an Authorization for Release of Medical Records form, given to them by the personal physician or they can download the form from the website ww.vivamd.com.

Copies of the patients medical records are sent to the VivaMD Regional Medical Center (RMC). The RMC is a regional office staffed by medically trained personal such as nurses. The RMC personal process and categorize the medical records. If images are available, they will be digitized and returned to the physician's office, if specified. Qualified medical personal at the RMC then categorize, format and forward the medical records to VivaMD's database warehouse.

A Smart Card is issued to the patient. The patient receives a member number and selects a pass word. The card is programmed with information from medical records into five formatted files, available via a card reader or the Internet. The information available on the card is emergency medical information, insurance-billing, immunizations, prescriptions and an admittance form.

The VivaMD Smart Card that each member receives provides global accessibility to their personal and medical information, via Smart Card reader's, the Internet or by a 24/7 globally accessible 800-telephone number. The card becomes the key to access the members information that is partitioned in sections with access stipulated by pass words and pin numbers. At the time of sign-up, the subscriber selects their own pass word and PIN number which becomes their access code. Through the Smart Card technology and Internet connectivity, a subscriber's medical records are placed in their wallet or purse and they are available anytime and anywhere with maximum security and privacy/piracy protection.

The personal medical records retrieval system presents records and notes on three simple charts easy to read, understand and use. Chart 1 is a medical Activity Report listed in chronological order. Chart 2 is an Encounter Summary from each visit, Chief Complaints, Diagnosis, Treatment and Medication. Chart 3 list all Medical Records and images of documents in 19 categories by chronological date. By clicking on the date, the document appears on the screen. The subscriber thus has all of their medical records, including old paper records from the doctors shelf, electronically available globally, on Internet connected devices.

### DESCRIPTION OF THE DRAWINGS

FIG. 1 is a block diagram of the novel personal medical records retrieval system;

FIG. 2 is an example of Chart I-ACTIVITY REPORT;

FIG. 3 is an example of Chart II-ENCOUNTER SUMMARY;

FIG. 4 is an example of a Chart III-MEDICAL RECORDS; and

FIGS. 5A, 5B and SC are a chart of guidelines to be used when entering information from a medical records into the MEDICAL RECORDS category/files summary.

### DESCRIPTION OF THE PREFERRED EMBODIMENT

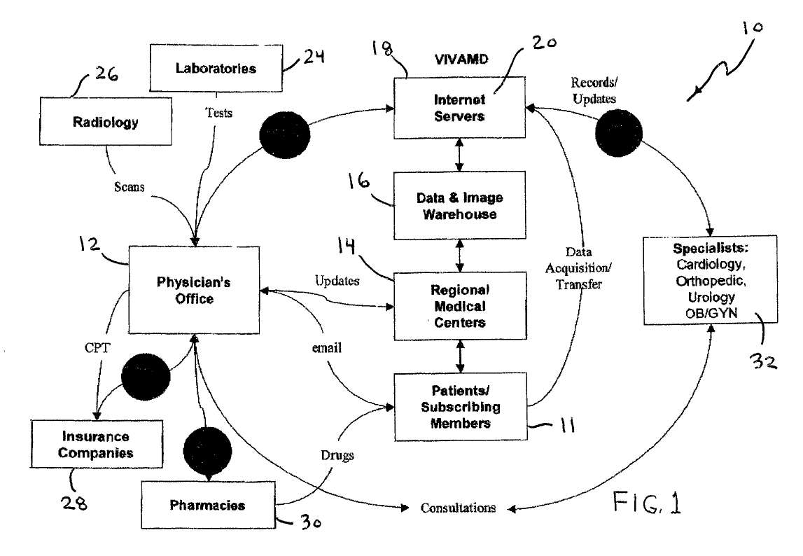

The novel medical records retrieval system will now be described by referring to FIGS. 1-5 of the drawings. The personal medical records retrieval system is generally designated numeral 10. It uses broadband telecommunication systems with vast data warehouse capabilities that are Internet based. What makes this system so unique, is that it encompasses a number of specifically identified characteristics and methodologies in both the technology and medical fields. Effective and accurate data collection about an individual (patient) to be analyzed, categorized, formatted and stored with Firewall security and privacy/pirating protection is a key element of the system. Display of this information in a format easily read and easily understood is also essential in educating and guiding the individual and their physician in optimizing the health care program. Computers can sort, format and statistically analyze “fixed data”. The personal medical records retrieval system combines that with “value judgements” of personal information and medical records accessed by medical professionals. This makes the personal medical records retrieval system different and is a key to its uniqueness and success.

FIG. 1 is a block diagram of personal medical records retrieval system 10. The patient (subscriber) 11 fills out a questionnaire with personal and medical history information either online or in the physicians office 12. The subscribing patient 11 signs a Medical Records Release Registration form and Regional Medical Center 14 receives the paper records from the patient and/or physicians office 12. At the regional medical center 14, the records are then scanned (images) and categorized and forwarded to data and image warehouse 16 and entered into the database there. The physician's office 12 can obtain the patients/subscribing members medical history directly through the website 18 on the Internet server 20. The website 18 is directly connected to the data base 16 and is accessible with the subscribing member's permission, password and access number. The physician's office 12 can order tests from laboratories 24 and scans from radiology 26 and these results would be transmitted to the physician's office 12 either by physical documents or through facsimiles sent over the telephone wires. These tests and scans along with updates from the physician's office would be either physically or electronically transmitted to Regional Medical Center 14.

CPT, an acronym for Current Procedural Terminology includes numerical codes for each procedure a physician would perform, that an insurance company 28 pays according to prescriptions, diagnosis, and dollar amounts. The information received from insurance company 28 would be transmitted in the form of updates to Regional Medical Center 14. Pharmacies 30 would receive prescriptions from the physicians office 12 and this information would also be provided through updates to Regional Medical Center 14. The drugs would be received by the patient/subscribing member 11.

If the physician's office 12 wishes the patient/subscribing member 11 to consult with a specialist 32, he would provide the specialist with proper access codes so the specialist can have the benefit of the patient's medical history, which they can obtain from the website 18. Some examples of specialists would be doctors specializing in cardiology, orthopedic, urology, ob/gyn and others.

Once the patient/subscribing member 11 has had its medical history loaded into the data base 16, they can directly receive or view this information by going to the website 18.

The personal medical records retrieval system 10 is a membership program based on Patient Relationship Management (PRM) technology, allowing webbase 24/7 access to critical medical information with integration of Smart Card technology and extensive data processing tools. This allows the medical community to access, analyze and integrate medical information from patient, primary care physician, ailment, treatment, medical history or any combination thereof. This private and secure and flexible PRM service enables the primary care physician and the patient to truly partner in an environment based on trust, confidence and the comfort of knowing information is available when and where it is needed. This web based environment enables true PRM applications connecting patients, physicians, insurance companies and care givers.

Each member 11 receives a VivaMD Health Card, a credit card sized Smart Card. Through smart readers, Internet connected PC's or wireless hand held units, 24/7 globally accessible telephone service will provide patient and authorized medical personal with instantaneously accessible local access of patient's medical history records. The system provides multi-level Firewall security with privacy/pirating protection. The VivaMD card also becomes the “key” to retrieve a patient's information which is partitioned in sections with access to each section as stipulated by passwords and pin numbers.

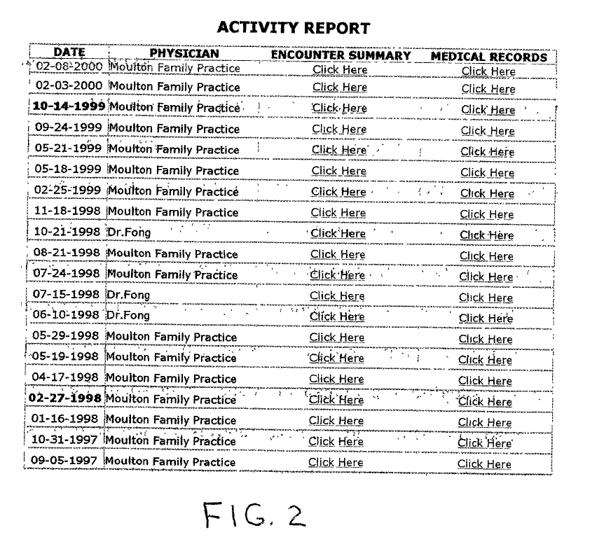

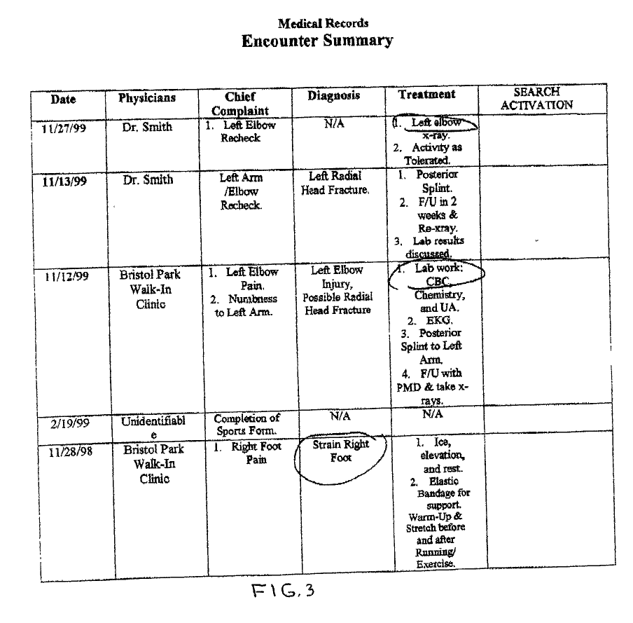

A patient's medical Activity Report chart, showing when the patient went to a physician, specialist, and hospital emergency is illustrated in FIG. 2. This chart would be found on the website 18.

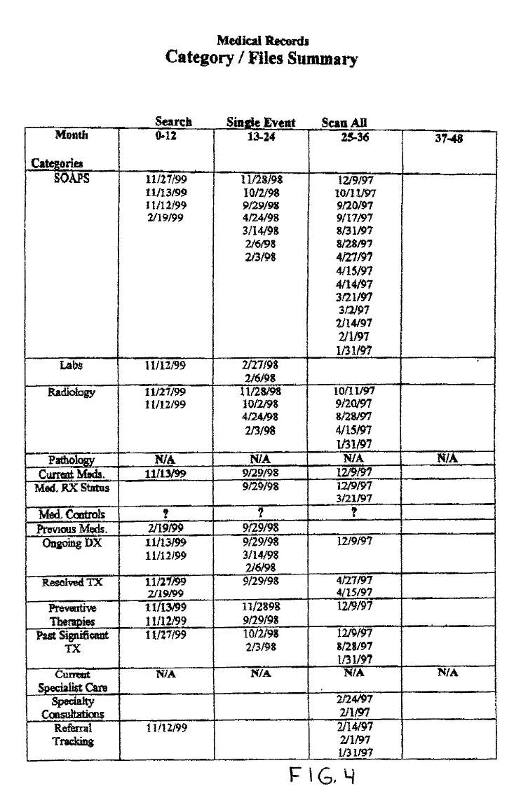

An example of an Encounter Summary chart is illustrated in FIG. 3 that sets forth a chronological listing of the patient's visits. The column entitled Chief Complaint explains why the patient went to the physician or medical facility. The Diagnosis column defines the physician's diagnosis of the problem. The Treatment column lists the physicians choice of treatment and medication.

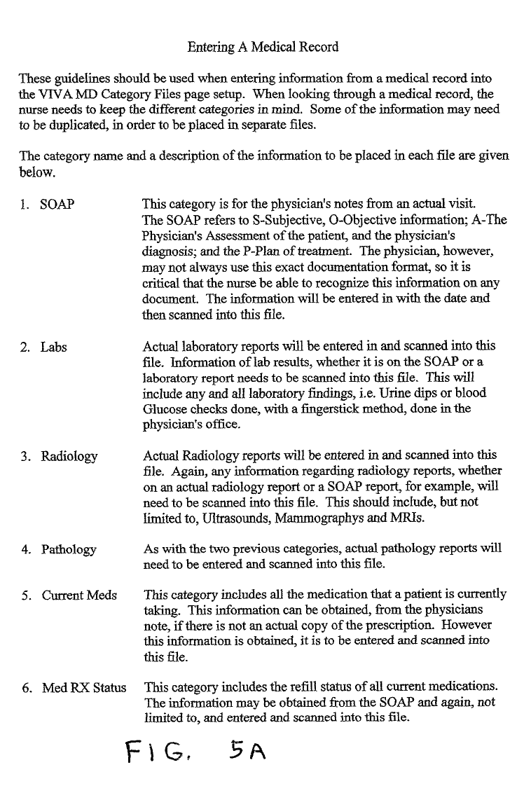

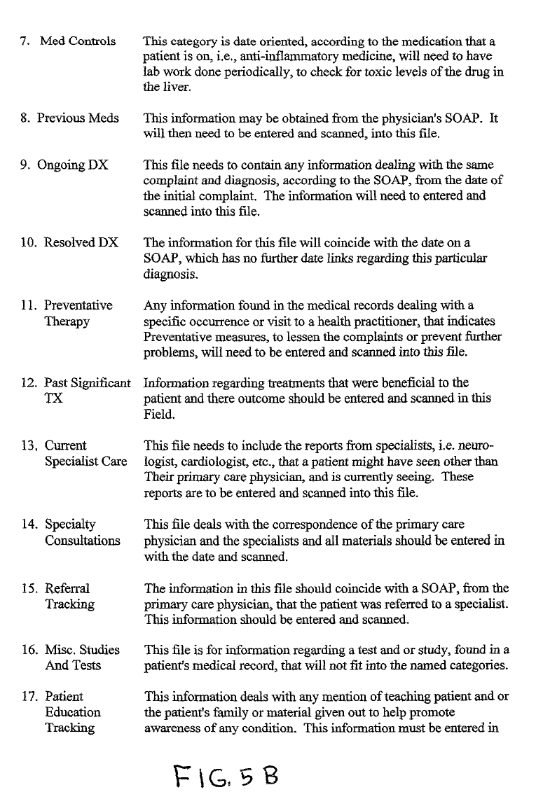

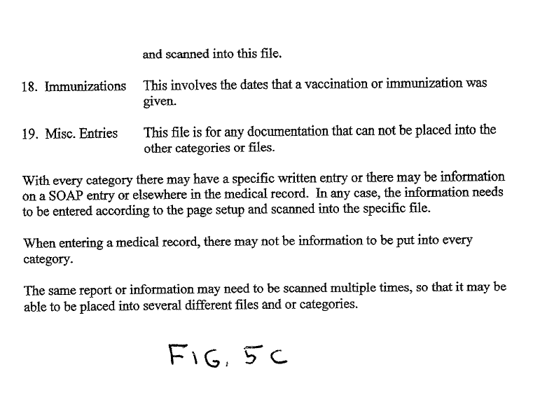

FIG. 4 is an example of the Medical Records chart that outlines the specifics of patients medical record file in detail in 19 categories. The information in the 19 categories has been gleaned from documents received from the physician's office 12, the laboratories 24, the radiology department 26 and all other sources of medical history. The trained medical personal in Regional Medical Centers 14 enter the proper information in the respective 19 categories. The guidelines for entering the medical information in the Medical Records chart illustrated in FIG. 4 is set forth in FIGS. 5A, B and C.

What is claimed is:

1. A personal medical records retrieval system comprising:
a remote medical records database having an Internet website;
a personalized access code for said remote medical records data base; and
means connecting a person (having said personalized access code) to said remote medical records database 24 hours a day and 365 days a year from locations throughout the world.

2. A personal medical records retrieval system as recited in claim 1 wherein said medical records database has a Firewall security and privacy/pirating protection system.

3. A personal medical records retrieval system as recited in claim 1 wherein means connecting a person to said medical records database is the Internet.

4. A personal medical records retrieval system as recited in claim 1 further comprising a Medical Service Center staffed by trained personnel; means connecting said Medical Service Center to said medical records database; said Medical Service center having a telephone number that can be called from anywhere in the world and a person's medical data from said medical records database can be transmitted over the telephone.

5. A personal medical records retrieval system as recited in claim 1 wherein said personalized access code can only be obtained by becoming a subscribing member to said personal medical records retrieval system.

6. A personal medical records retrieval system as recited in claim 5 wherein said personalized access code comprises a user name and a password.

7. A personal medical records retrieval system as recited in claim 1 wherein said medical records database comprises an Activity Report chronologically listing by date when a person went to any doctor, any medical specialist and any hospital and also listing the name of the doctor, medical specialist and hospital.

8. A personal medical records retrieval system as recited in claim 7 wherein said Activity Report has an Encounter Summary column and a Medical Records column each of which may be clicked on with a computer mouse for each chronological date.

9. A personal medical records retrieval system as recited in claim 7 wherein said Activity Report contains at least the last 3 years of a person's medical care.

10. A personal medical records retrieval system as recited in claim 8 wherein said Encounter Summary column for each chronological date lists the person's medical complaints, the doctor's diagnosis, the treatment provided and any medications prescribed.

11. A personal medical records retrieval system as recited in claim 8 wherein said Medical Records column (for each chronological date listed) when clicked on with a computer mouse lists a person's medical history in at least 10 different categories; the information in each of said categories having been inserted therein by trained personnel (in a Medical Service Center) that have reviewed (1) a medical history questionnaire completed by the patient and (2) medical records from the patient's doctors.

12. A personal medical records retrieval system as recited in claim 11 wherein some of said categories are captioned (1) SOAPS, (2) Labs, (3) Radiology, (4) Pathology, (5) Current Meds, (6) Med RX Status, (7) Med. Controls, (8) Prev. Meds., (9) Ongoing DX, (10) Resolved TX, (11) Preventive Therapies, (12) Past Significant TX, (13) Current Specialist Care, (14) Speciality Consultations, (15) Referral Tracking, (16) Misc. Studies/Tests, (17) Out Patient Services, (18) Patient Education Tracking, (19) Immunization Status, and (20) Misc. Entries.

13. A personal medical records retrieval system as recited in claim 11 wherein said medical history questionnaire is a physical document and is completed by writing the answers.

14. A personal medical records retrieval system as recited in claim 11 wherein said medical history questionnaire is completed online over the Internet.

15. A personal medical records retrieval system as recited in claim 4 wherein new and developing medical information from a person's doctors can be transmitted directly to said Regional Medical Center thereby eliminating the need for patient medical file folders in the doctor's office.

16. A personal medical records retrieval system as recited in claim 3 wherein with a person's permission and their personalized access code, a person's personal doctor can access that person's medical history from said medical records database.

17. A personal medical records retrieval system as recited in claim 16 wherein a consulting medical specialist can access a person's medical history from said medical records database with a person's permission and their personalized access code thus eliminating the need to physically transfer a copy of a person's medical history files from said person's personal doctor to said consulting medical specialist.

18. A personal medical records retrieval system as recited in claim 1 further comprising a Smart Health Card that contains a small computer in the form of a computer chip with a memory embedded that contains a person's medical history.

19. A personal medical records retrieval system as recited in claim 18 further comprising a medical passport into which is inserted said Smart Health Card and further comprising a CD-ROM disc that has a person's complete medical records on it and it can be read on any PC or laptop, with proper authorization.

20. A personal medical records retrieval system as recited in claim 18 wherein said Smart Health Card can be read on a card reader in a physician's office, in a hospital, in emergency vehicles and any other place that is equipped with a card reader.
